(19) United States
(12) Patent Application Publication
(10) Pub. No.: US 2002/0018256 A1
(43) Pub. Date: Feb. 14, 2002

(54) Optical digital pattern recognizing apparatus and method

(76) Inventor: Joseph R. Child, Alexandria, VA (US)

Correspondence Address: LOWE HAUPTMAN GOPSTEIN, GILMAN AND BERNER LLP, SUITE 310, 1700 DIAGONAL ROAD, ALEXANDRIA, VA, 22314

(21) Appl. No.: 09/927,531

(22) Filed: Aug. 13, 2001

Related U.S. Application Data
(60) Provisional application No. 60/224,905, filed on Aug. 14, 2000.
(60) Provisional application No. 60/229,195, filed on Aug. 30, 2000.

(51) Int. Cl. G06E 1/00; G02F 3/00

(52) U.S. Cl. 359/107; 359/108

(57) ABSTRACT

A determination is made as to whether sequential binary bits modulating optical energy have a certain bit pattern by applying the energy to an optical line having plural points from which optical energy is derived. The propagation speed of the optical energy in the line, the duration of the bits and the locations of the points are such that each of the binary bits passes by each of the points for approximately the same time, the propagation time of the energy between adjacent points equals the duration of each bit and the bits at the points are substantial replicas of the sequential binary bits modulating the optical energy. The values of the bits at the points are compared with the certain bit pattern to provide the determination.

### CROSS REFERENCE TO RELATED APPLICATION

This utility application is a continuation in part of my Provisional Patent Applications, Ser. No. 60/224,905, filed Aug. 14, 2000, and Ser. No. 60/229,195, filed Aug. 30, 2000.

### FIELD OF THE INVENTION

The present invention relates generally to optical signal processing and more particularly to an optical signal pattern recognizing method and apparatus wherein a pattern of optical signal bits is applied to an optical line having plural outputs.

### BACKGROUND ART

Optical telecommunication systems have become the dominant carrier of all long haul voice and data telecommunication traffic. The rate at which the fiber optics industry is growing has outstripped all industry estimates of the past and there is no clear understanding of what the eventual aggregate capacity of such systems will be in the future. Lead times for single mode cable are steadily increasing such that it recently grew to more than one year from major manufacturers.

In expanding the use of optical fiber, higher and higher data rates over each fiber have been sought. Some single mode optical fiber can carry large amounts of data, hundreds or thousands of gigabits per second (gbps). The only practical way to realize this capacity is to transmit multiple independent carrier frequencies (i.e., colors or wavelengths), each modulated with a portion of the data. Systems currently being deployed use this technique, called dense wavelength division multiplexing (DWDM). In DWDM systems, many light optical signals of different color are combined onto a single optical fiber for long haul transmission. Each color is modulated separately and carries data that are independent of the data being carried by other colors in the same fiber. At the receive end, the colors are separated using prisms and other optical techniques. The separated colors are demodulated to extract the transmitted data.

DWDM allows multiple data signals to be carried over a fiber without having to modulate any one optical carrier with more than 10-40 gbps of data. Data rates higher than this are not practical with currently available technology.

DWDM is expensive to implement. The filters for separating the colors have as many as 500 layers of deposited material and the product costs are high. There are also technical problems with DWDM, whereby the colors interact with each other within the cable causing interference having adverse affects on the data signals in the fiber.

The rates that can be implemented in practical electrical circuitry associated with optical systems are other limitations on optical transmission systems. Passing data signals in electrical format at data rates in the hundreds of gbps is impractical. Therefore, modulating light signals at rates above 40 gbps, and sometimes as low as 10 gbps, is commonly recognized as the practical limit of the modulation rate that can be used on a single optical carrier frequency or color.

In current optical transmission systems, data are received in optical format and then converted to electrical format before being managed in logic. A 10 gbps signal, before being read or otherwise evaluated for processing, is typically converted to electrical format and immediately subdivided into four data rate electrical signals using an industry standard deserializer. The limitation at issue is that currently available computers do not execute logic steps at rates as high as 10 billion bits per second. The data rate must be reduced to a much lower rate before practical computer logic is able to read and manage the signals. In many cases, the data rate is reduced to much lower than 2.5 gbps before the data are read.

Due to electronic circuitry limitations, optical systems have not reached their potential of carrying much higher data rates per optical carrier. Modulation techniques currently exist in laboratories whereby light is modulated at multiple terabits per second. Implementing these high data rates in practical equipment continues to beg the question of how to implement reception using practical electrical circuitry.

It is, accordingly, an object of the present invention to provide a new and improved method of and apparatus for reading bit patterns of optical signals.

An additional object of the present invention is to provide a new and improved method of and apparatus for reading optical data patters while the data are still in optical format and for matching the data against another data bit pattern that can be programmed into the device. It is preferable for the process to be conducted solely in the optical domain, thereby avoiding the difficulties of electrical circuits attempting to operate at very high data rates. The detection process must be done in very little time, more quickly than can be done in electronic circuitry. These operations thus are desirably performed without converting any of the optical signals to electrical format.

Another object of the invention is to provide a new and improved method of and apparatus for comparing bit patterns of optical signals by utilizing optical signal processing techniques and apparatus.

A further object of the invention is to provide a new and improved method of and apparatus for comparing bit patterns of optical signals with known bit patterns, wherein the processing is performed optically.

An additional object of the invention is to provide a new and improved method of and apparatus for comparing bit patterns of optical signals at processing speeds which cannot be achieved with currently existing electronic circuitry.

An added object of the invention is to provide a new and improved method of and apparatus for detecting the presence of optical data packets by utilizing optical signal processing techniques and apparatus.

### SUMMARY OF THE INVENTION

In accordance with one aspect of the invention a determination is made if a sequence of binary bits modulating optical energy has a certain bit pattern by applying the modulated optical energy to an optical line having plural points from which optical energy is derived. The propagation speed of the optical energy in the optical line, the duration of the optical bits and the locations of the points are such that each of the binary bits passes by each of the points for approximately the same time and the binary bits at the points are a replica of the sequential binary bits modulating the optical energy. A comparison is made of the values of the bits at the points with the bit pattern to provide the determination.

The invention can be used for various purposes requiring a first optical bit sequence to be compared with a second bit sequence, e.g. in an optical communication system wherein the first optical bit sequence is included in a message and is commensurate with an address of a receiver for a message and the second bit sequence is stored at the receiver for the message. The message data stream (i.e., bits) is continuously compared to a known pattern that has been programmed into the device. The invention does not require clocking of data bits nor synchronization with the data stream to perform continuous comparison of the data stream with the programmed pattern.

The certain bit pattern can be a predetermined pattern, in which case the predetermined bit pattern is stored. Thus, the device preferably matches fixed data bit patterns embedded in the device with data in a data stream preferably moving through the circuit at the speed of light. The device recognizes bit patterns in the data stream and performs logic functions based on the results of the matching. When a match occurs, the device optically signals associated circuitry to perform logical functions related to the data stream.

Alternatively, the certain bit pattern can be the pattern of a second bit sequence, in which case the second bit sequence is applied to a second optical line having plural points from which optical energy is derived. In the alternative situation, the comparison is made of the values of the bits at corresponding points of the two optical lines, assuming that the bit sequences applied to the two optical lines are synchronized.

Preferably, the comparing step is performed with optical circuitry to enable signal processing to be performed at speeds much higher than can be achieved electronically. The optical processing is performed with known, conventional optical processing circuits, such as exclusive OR and AND gates. Plural exclusive OR gates are provided, each having a first input port responsive to the optical signal at a point on the line and a second input port responsive to a bit of the certain bit pattern. The exclusive OR gates have output ports which drive AND gates that are connected in a tree or cascaded configuration to derive the signal which indicates whether or not the sequential binary bits have the certain bit pattern.

In certain instances, the comparing step results in a delay being introduced into bits being processed to produce the comparison. In such an instance, the optical energy is delayed so there is synchronism with the bits at a point which causes the comparison to be derived and the bits being processed to produce the comparison. In some of these situations, the delay is introduced in the line, while in other situations the delay is introduced in the optical processing apparatus.

In the preferred embodiment, the propagation speed of the optical energy in the optical line, the duration of the optical bits, and the locations of the points along the line are such that the propagation time of the optical energy in the line between at least some pairs of adjacent points is equal to the duration of each bit.

In one application, the output of the device redirects an optical data packet by operating optical switches. For the optical packet application, each packet, as transmitted, includes a starting bit pattern indicative of a valid data packet, followed by an address of a receiver to which the packet is being directed. A receiver responsive to such a packet includes a pair devices for comparing (1) the starting bit pattern of the transmitted packet with a stored indication of the starting bit pattern of the transmitted packet, and (2) the receiver address contained in the transmitted packet with a stored indication of the address of the receiver. In response to both comparisons yielding positive results, the receiver is enabled to be responsive to the data message included in the packet. Many other logic functions can be initiated based on the results of optically based pattern matching.

There is a tendency for very short duration optical pulses to be erroneously derived by the optical processing circuitry of the invention, as well as by other types of optical processing circuitry. These pulses, which typically have durations equal to or less than half the duration of a pulse or bit in the sequence, are filtered out in accordance with a further aspect of the invention. The filtering is performed by optical circuitry including an optical delay line which is responsive to the optical pulse. The delay line has an output which drives one input port of an optical AND gate, having a second input port responsive to an undelayed replica of the optical pulse. The delay introduced by the delay line is equal to the maximum duration of these erroneously derived pulses.

The above and still further objects, features and advantages of the present invention will become apparent upon consideration of the following detailed descriptions of several specific embodiments thereof, especially when taken in conjunction with the accompanying drawings.

### BRIEF DESCRIPTION OF THE DRAWING

FIG. 1 is a block diagram of an optical transmitter and a portion of an optical receiver including a preferred embodiment of the present invention which includes optical circuitry particularly adapted to compare four sequential optical bits with four stored bits having predetermined values;

FIG. 2 is a diagram helpful in describing the operation of the comparison portion of the receiver illustrated in FIG. 1;

FIG. 3 is a block diagram of another embodiment of the present invention, including optical circuitry particularly adapted to compare seven sequential optical bits with seven stored bits having predetermined values;

FIG. 4 is a block diagram of another embodiment of the present invention, including optical circuitry particularly adapted to compare four sequential optical bits with four stored bits having predetermined values, wherein the optical circuitry includes cascaded AND gates;

FIG. 5 is a block diagram of another embodiment of the present invention, including optical circuitry particularly adapted to compare five sequential optical bits with five stored bits having predetermined values, wherein the optical circuitry includes cascaded AND gates;

FIG. 6 is a block diagram of another embodiment of the present invention including optical circuitry and optical amplifiers in a line responsive to four sequential optical bits that are compared with four stored bits having predetermined values;

FIG. 7 is a block diagram of a receiver including a pair of devices of the type illustrated in any one of FIGS. 1 and 3-6, wherein the devices and other optical circuitry are used to determine if the receiver is addressed to receive a valid data packet including sequential optical bits;

FIGS. 8A and 8B are waveforms useful in describing the nature of input and output signals supplied to gates of the optical processing circuitry of any one of FIGS. 1 and 3-7; and

FIG. 9 is a block diagram of optical circuitry for filtering out short duration optical pulses which can occur in the optical circuitry of any one of FIGS. 1 and 3-7, as well as other optical circuitry.

### DETAILED DESCRIPTION OF THE DRAWING

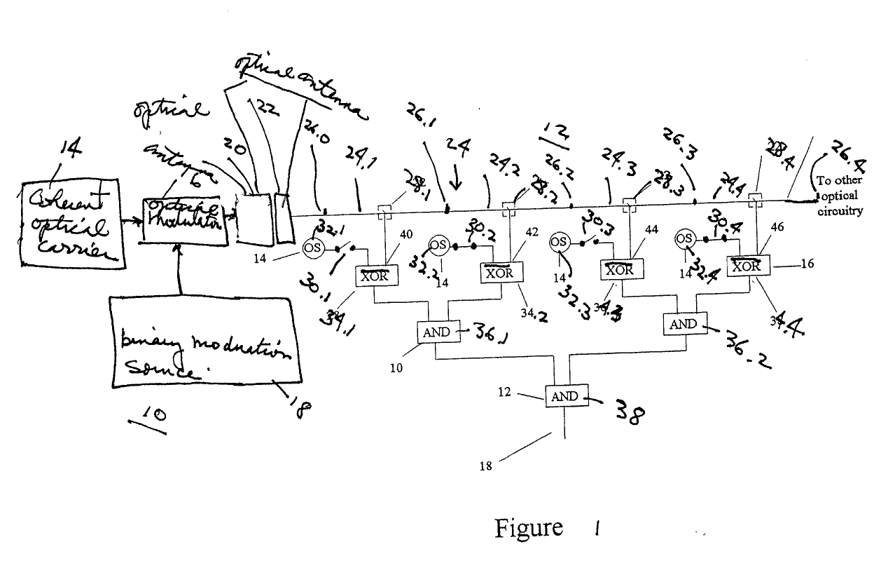

Reference is now made to FIG. 1 of the drawing wherein optical transmitter 10 is illustrated as transmitting an optically modulated coherent carrier wave to optical receiver 12. Transmitter 10 includes coherent optical carrier source 14 which drives one input of optical modulator 16, having a second input responsive to binary modulation source 18. Modulator 16 derives a coherent wave that is modulated by sequential pulses that source 18 supplies to the modulator. Typically, the modulated coherent wave that modulator 16 derives is sequentially on and off in response to and at the same rate as sequential equal duration binary bits that source 18 derives. It is to be understood, however, that binary modulation source 18 can modulate the coherent wave which source 14 derives in other ways, such as by bi-phase modulation. In addition, if on off modulation is employed, it is not necessary for source 14 to be coherent, although coherent optical carriers are transmitted much more efficiently and effectively than incoherent optical carriers. An optical line at the output of modulator 16 supplies the modulated coherent wave output of the modulator to optical antenna 20, which in turn emits a modulated coherent wave that is a replica of the wave derived by modulator 16. Optical antenna 20 can be of any suitable type, such as the type disclosed in my co-pending, commonly assigned Application Ser. No 09/608,610.

The optical wave emitted by antenna 20 is incident on optical antenna 22 of receiver 12. Antenna 22 can be of any suitable type, such as disclosed in my previously mentioned co-pending application. Under ideal circumstances, antenna 22 derives an optical wave that is a replica of the optical wave emitted by optical antenna 20 of optical transmitter 10. The optical output of antenna 22 drives optical line 24 including four equal length and equal delay time segments 24.1, 24.2, 24.3 and 24.4. Optical line 24 can be any suitable distributed parameter structure (e.g., a fiber optic line or a length of optically transparent material) or discrete optical processing elements (such as optical gates) having precise optical delay times.

The propagation velocity and delay times of the optical energy in each of segments 24.1-24.4 is the same. The propagation velocity and the length of segments 24.1-24.4 and the durations of the equal duration bits which source 18 modulates on carrier 14 are such that one of the bits occupies one of the segments at any one time. The propagation speed of the optical energy in optical line 24, the duration of the optical bits and the locations of a specific point in each of the segments are such that each of the binary bits passes by each of the specific points for approximately the same time and the binary bits at the specific points are a replica of the sequential binary bits that modulate the optical energy in transmitter 10.

The boundaries of equal length segments 24.1-24.4 are indicated by lines 26.0-26.4, such that lines 26.1, 26.2 and 26.3 respectively represent the boundaries between adjacent segments 24.1 and 24.2, adjacent segments 24.2 and 24.3, and adjacent segments 24.3 and 24.4, while lines 26.0 and 26.4 respectively represent the beginning of segment 24.1 and the end of segment 24.4. The specific point in each of the segments 24.1-24.4 is at the center of the segment. Optical fiber line 24 continues past segment 26.4 and is connected to additional optical circuitry (not shown) which is driven by the optical bits propagating in the line past segment 26.4.

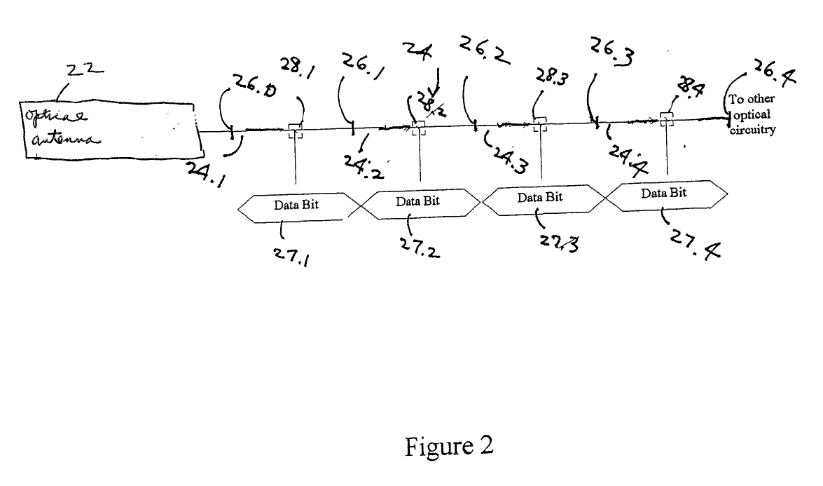

FIG. 2 includes an illustration of the physical length of four optical data pulses or bits 27.1-27.4 passing, at a particular instant of time, through optical line 24. At the particular instant of time illustrated in FIG. 2, bits 27.1-27.4 respectively occupy all of segments 24.1-24.4. In general, the physical length, at any instant of time, of all the data bits moving at speed of light through line 24 must be the same length as the physical distance between the specific points of adjacent segments of the optical line 24. The physical length of the data bits on optical line 24 is a function of the rate at which the optical signal was modulated at transmitter 10, as well as the propagation speed of the data bits through line 24. Hence, higher modulation rates produce shorter duration and shorter length bits. Processing higher data rates requires smaller processing circuitry and shorter line segments 24.1-24.4. Data rates on the order of terabits per second lend themselves to circuitry small enough to be very economical to produce.

At the center point of each of segments 24.1-24.4 is an optical splitter 28, such that optical splitters 28.1, 28.2, 28.3 and 28.4 are respectively at the centers of segments 24.1, 24.2, 24.3 and 24.4. At a particular instant of time, as illustrated in FIG. 2, bits 27.1-27.4 are centered on splitters 28.1-28.4 and extend to boundaries 26.0-26.4, such that bit 27.1 is centered on splitter 28.1 and extends between boundaries 26.0 and 26.1, bit 27.2 is centered on splitter 28.2 and extends between boundaries 26.1 and 26.2, etc.

Each of optical splitters 28 includes an input port and two output ports, a first of which supplies optical energy to line 24 and a second of which supplies optical energy to an additional optical line. Typically, the vast majority, such as over 99 percent, of the energy at an input port of an optical splitter 28 is supplied to the first output port of the optical splitter and the remaining portion of the energy at the input port of a particular optical splitter is supplied to the second output port. The energy at the second output ports of optical splitters 28.1-28.4 drives optical circuitry for indicating whether a sequence of four binary optical bits on line 24 has a certain value.

In the circuitry of FIG. 1, the certain value has a predetermined, stored pattern, determined by the open and closed states of optical switches 30.1, 30.2, 30.3 and 30.4. Switches 30.1-30.4 are respectively driven by static optical sources 32.1-32.4. Alternatively, a single static optical source can drive switches 30.1-30.4 in parallel or the switches can be eliminated and the function thereof can be replaced by the presence and absence of optical energy. In the circuit of FIG. 1, the binary bits in line segments 24.1, 24.2, 24.3 and 24.4 are respectively compared with optical binary bits having certain values of 0,1,0,1. It is to be understood, however, that the certain value need not necessarily be a stored pattern and that the concept of the invention can be used to compare two dynamic bit sequences.

The optical circuitry for comparing the binary bits in line segments 24.1-24.4 with the values of the optical bits selectively coupled through optical switches 30.1-30.4 includes negative optical exclusive OR gates 34.1, 34.2, 34.3 and 34.4 each having two input ports. The first input port of each of gates 34.1-34.4 is connected to the optical line connected to the second output ports of splitters 28.1-28.4, respectively. The second input port of each of gates 34.1-34.4 is respectively connected to optical switches 30.1-30.4. Each of negative exclusive OR gates 34.1-34.4 includes an output port which the gate supplies with no optical energy when the two inputs to the gate differ from each other; when the two inputs to the gate are the same, the gate supplies optical energy to its output port. Gates 34.1-34.4 compare the values of the binary inputs thereof. The gates can also be configured as optical exclusive OR gates, in which case the gates supply (1) optical energy to the output ports thereof when both input ports thereof have different binary signals applied to them and (2) no optical energy to the output ports thereof when both input ports thereof have the same binary signals applied to them. Both types of gates are considered to be comparison gates.

The output ports of negative exclusive OR gates 34.1-34.4 drive an optical tree network including optical AND gates 36.1 and 36.2, as well as optical AND gate 38. Each of AND gates 36.1, 36.2 and 38 has two input ports and an output port; each of the AND gates supplies its output port with optical energy only when optical energy is simultaneously supplied to both of its input ports. Thus, gate 38 supplies optical energy to its output port only in response to the binary bits on optical line segments 24.1, 24.2, 24.3, 24.4 respectively having the values 0,1,0,1.

The structure illustrated in FIG. 1 can be constructed with discrete optical components or optical circuitry integrated onto a microchip. Integrating the structure on a microchip requires very high data rates because there is a close relationship between the size of components on the chip and the size of the data bits passing at the speed of light through the pattern recognition, that is, matching circuitry, of the microchip optical components. If the optical circuitry is integrated onto a microchip having components in the millimeter range, the bit rate can the 300 gigabits or greater.

The optical logic components illustrated in FIG. 1 and in the remaining figures, including negative exclusive OR gates, AND gates and optical splitters, are well known in the prior art and the structure thereof can be found in materials available from the International Society For Optical Engineering at www.spie.org and from other sources of optical devices available in the public domain. While the processing circuitry has been described as being optical, it is to be understood that optical signal processing provided by gates 34, 36 and 38 can be replaced by electronic gates if relatively slow processing speeds can be tolerated for the bit rate of the modulated signal. Of course, it is necessary for like optical and/or electronic components to have substantially the same or identical response times.

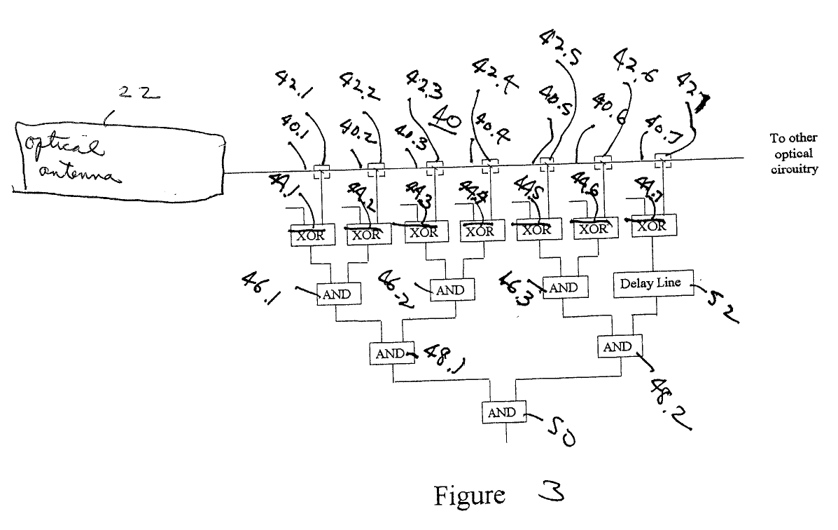

The number of data bits that can be included in the matching pattern is limited only by the length of the optical fiber line along which the bits propagate. The number of data bits in the matching pattern need not be even. FIG. 3 is a block diagram of a device for determining if seven sequential optical bits on optical line 40 match a predetermined pattern. Line 40 includes seven equal length segments 40.1-40.7 having characteristics the same as segments 24.1-24.4 of line 24, FIG. 1. Thus, optical splitters 42.1-42.7 are respectively located in the centers of segments 40.1-40.7. Splitters 42.1-42.7 respectively drive one input of each of optical negative exclusive OR gates 44.1-44.7, each having a second input indicative of a bit of the stored pattern to be matched.

Negative exclusive OR gates 44.1-44.7 drive a logic tree network including optical AND gates 46.1-46.3, optical AND gates 48.1 and 48.2, as well as optical AND gate 50. In response to the seven bits in segments 40.1-40.7 being the same as the bit supplied to the second input ports of the negative exclusive OR gates 44.1-44.7, AND gate 50 derives optical energy supplied to additional circuitry (not shown in FIG. 3).

The logic tree network also includes optical delay line 52, having a delay time equal to the equal processing time of each of AND gates 46.1-46.3. Thereby, the optical output signal of delay line 52 occurs simultaneously with the optical output signals of AND gates 46.1-46.3. The structure of delay line 52 can be implemented by appropriately increasing the length of the fiber-optic line connected between the output of negative exclusive OR gate 44.7 and the input of AND gate 48.2; alternatively, the delay line function can be implemented by an additional AND gate having the same properties as AND gates 46.1-46.3, wherein the additional AND gate has one input responsive to the output of negative exclusive OR gate 44.7 and a second input driven by a constant source of optical energy.

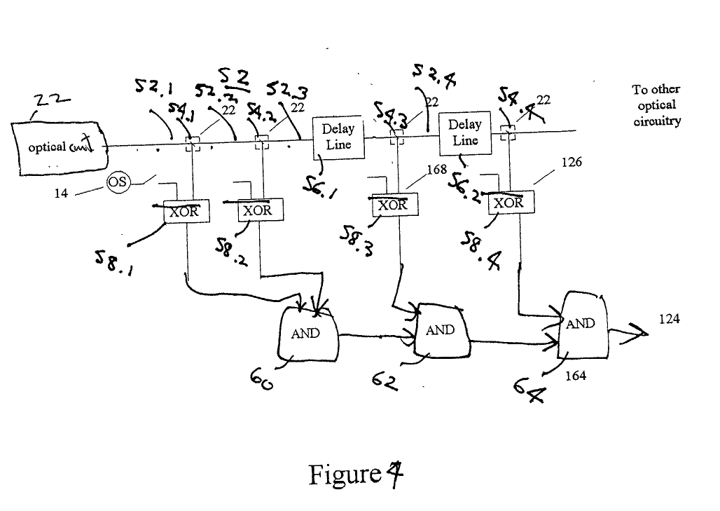

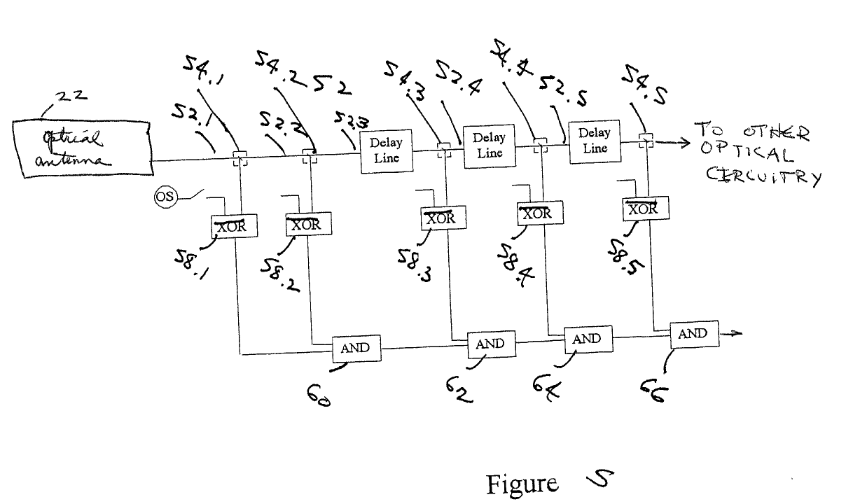

The logic tree AND gate configurations of FIGS. 1 and 3 can be replaced by cascaded optical AND gate circuitry, as illustrated in FIGS. 4 and 5, which are respectively designed to match four and five bit sequences with stored four and five bit predetermined patterns.

The four bit matching circuit of FIG. 4 includes optical line 52 having segments 52.1-52.4, respectively including optical splitters 54.1-54.4. Segments 52.1 and 52.4 and splitters 54.1 and 54.2 are configured identically to segment 24.1 and 24.2 and splitters 28.1 and 28.2, FIG. 1. Because the optical logic circuitry driven by splitters 54.1-54.4 includes cascaded AND gates, rather than AND gates connected in a tree configuration, equal duration delay lines 56.1 and 56.2 are respectively included in segment 52.3 and 52.4 of FIG. 4. The lengths of delay lines 56.1 and 56.2 are such as to compensate for the delay introduced by the cascaded AND gates. It is to be understood that other elements can be used as delay elements, as described supra, in connection with FIG. 3.

The optical circuitry for deriving an optical signal in response to a match existing between the optical binary bits in segments 52.1-52.4 and the four bit pattern programmed into the optical circuitry of FIG. 4 includes optical negative exclusive OR gates 58.1-58.4, each having a configuration and connections identical to the configuration and connections of the optical negative exclusive OR gates 34.1-34.4 of FIG. 1. Negative exclusive OR gates 58.1 and 58.2 include output ports connected to input ports of optical AND gate 60, in turn having an output port connected to one input port of optical AND gate 62. A second input port of AND gate 62 is connected to be responsive to the output signal of negative exclusive OR gate 58.3. AND gate 62 includes an output port connected to one input port of optical AND gate 64, having a second input port connected by a suitable optical line to the output port of negative exclusive OR gate 58.4.

AND gates 62 and 64 introduce delays between the input and output signals thereof. For example, there is a finite delay between the leading edge of optical energy being derived at the output port of AND gate 62 relative to the time that both input ports of AND gate 62 have optical energy applied to them. There is also a delay associated with the output port of AND gate 62 going dark, in response to one input port of the AND gate going dark, after both input ports of the AND gate were illuminated. Generally, these two delay times are the same or are sufficiently close to each other as to be the same for engineering purposes. The delay introduced by delay line 56.1 equals the delay time associated with AND gate 62. Similarly, the delay time introduced by delay line 56.2 equals the delay associated with AND gate 64.

AND gate 64 supplies optical energy to its output port for a period equal to a one bit period of the bits on optical line 52 each time there is a match between the bit sequence on line 52 and the stored bit pattern supplied to the matching circuit. The same is true of the configurations of FIGS. 1 and 3. To achieve correct synchronism of the matching circuitry of FIG. 4 with the bits propagating in line 52, it is necessary for splitters 54.3 and 54.4 to be positioned so that the center of a processed bit in the sequence is at these splitters simultaneously with the centers of the next two bits in the sequence being at splitters 54.1 and 54.2. In the configuration of FIG. 4, the delay time between the leading edge of the optical energy at the output of AND gate 64 and the occurrence of the matching bit sequence on line 52 equals the delay times associated with processing optical energy in negative exclusive OR gates 58 plus the sum of the processing times of AND gates 60, 62 and 64. Hence, the delay time in the FIG. 4 configuration can be thought of as four processing units. In contrast, the delay time between a leading edge of an output signal of AND gate 38, FIG. 1, and a match occurring in line 24 is only three processing units because the tree configuration of FIG. 1 can detect a match with fewer cascaded components. This is true even though both circuits require three AND gates to determine a match for a four bit sequence.

Reference is now made to FIG. 5 of the drawing, a block diagram of optical circuitry for detecting a match between a five bit sequence and a five bit stored pattern. The circuitry of FIG. 5 is identical to the circuitry of FIG. 4, except that FIG. 5 includes an additional optical delay line segment 52.5, an additional optical splitter 54.5, an additional optical delay line 56.3, an additional optical negative exclusive OR gate 58.5 and an additional optical AND gate 66. Each time a match occurs between the five bit sequence on line 52 and the stored bit pattern of FIG. 5, AND gate 66 derives optical energy for a one bit period. There is a five unit processing delay time between the leading edge of the output of AND gate 66 and the occurrence of the match on optical line 52.

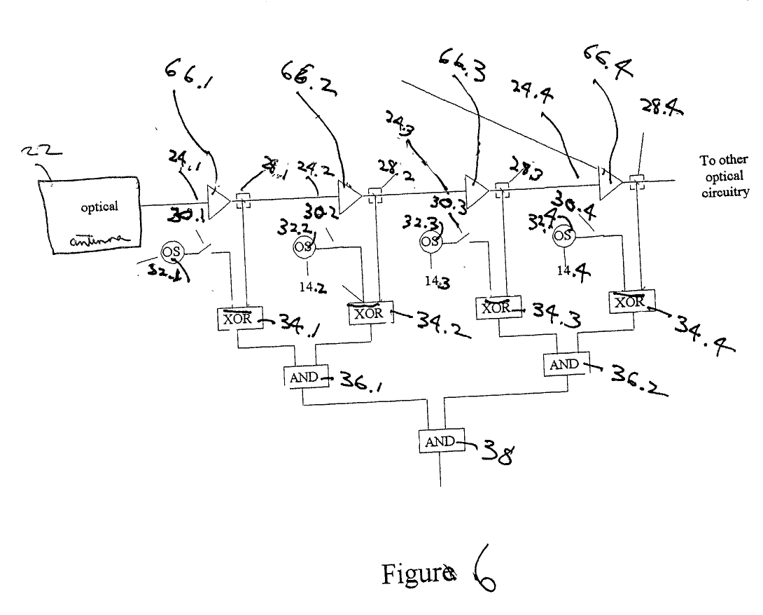

In many instances, the intensity of the optical energy incident on antenna 20, FIG. 1, is insufficient to drive fiber optic line 24 and the optical fiber matching circuitry. In such instances, an optical amplifier is inserted into optical line 24 in at least one of segments 24.1-24.4. In the configuration illustrated in FIG. 6, each of segments 24.1-24.4 includes a separate optical amplifier, such that segments 24.1, 24.2, 24.3 and 24.4 respectively include optical amplifiers 66.1, 66.2, 66.3 and 66.4. Amplifiers 66.1-66.4 are respectively connected immediately upstream of splitters 28.1-28.4 in optical line segments 24.1-24.4. If only some of segments 24.1-24.4 includes an optical amplifier, the length of each segment that does not include an optical amplifier must be adjusted to account for the delay time associated with the amplifiers. This is important to provide synchronism between the bits on line 24 and beam splitters 28.1-28.4. In particular, the delay times of the line lengths and the amplifiers are such that when one of the bits in the bit sequence is centered on one of the splitters, all bits in the sequence are centered on the splitters.

A pair of the pattern recognizers of the type disclosed in any one of FIGS. 1 and 3-6, can be employed in an addressed optical receiver responsive to an optical packet including a predetermined sequence of starting bits followed by sequential bits indicative of the address of the receiver which is to receive the data packet. The starting bits are in a pattern indicative of a valid data packet being present. The number of sequential bits in the starting bit pattern can be the same as or different from the number of bits in the address.

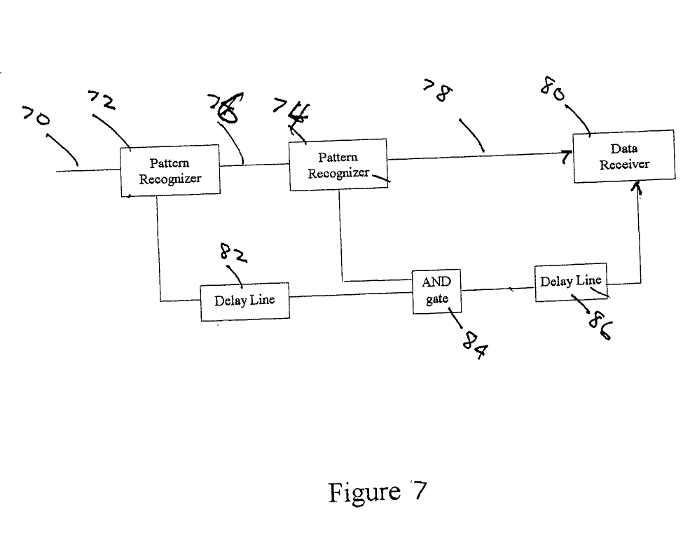

FIG. 7 is a block diagram of a receiver including optical line 70, connected to be responsive to the output of an optical antenna (not shown in FIG. 7). Optical line 70 drives optical pattern recognizer 72, having an output port which drives, via optical line 76, an input port of optical pattern recognizer 74. Pattern recognizers 72 and 74 are preferably of a type illustrated in any one of FIGS. 1 or 3-6. In response to the bit sequences on the optical lines in pattern recognizers 72 and 74 being the same as the stored patterns in the pattern recognizers, the pattern recognizers supply optical energy pulses to the output ports thereof. Each output pulse has a duration equal to the duration of one of the bits in the bit sequence supplied to the pattern recognizer input port.

Pattern recognizer 74 has an output port connected to optical line 78, which supplies sequential binary optical pulses to an input port of optical data receiver 80. Receiver 80, however, is enabled to be responsive to the optical pulses supplied to its input port only in response to pattern recognizers 72 and 74 signaling that the received packet had a valid starting bit pattern and that the receiver was addressed.

To these ends, the output port of pattern recognizer 72 drives optical delay line 82, having an output port connected to an input port of optical AND gate 84. The delay time of delay line 82 is such that both input ports of AND gate 84 are simultaneously supplied with optical energy for one bit period in response to the sequential bits supplied to pattern recognizers 72 and 74 both matching the patterns stored by these pattern recognizers.

Optical AND gate 84 includes an optical output port which drives input port of optical pulse stretcher 86, having an output port connected to an enable input of optical data receiver 80. Optical pulse stretcher 86 stretches the bits supplied to its input port to a period sufficient for the entire data stream on optical line 78 to flow through the input port of data receiver 80.

The matching circuits of FIGS. 1 and 3-6 operate on a continuous basis, as opposed to sampling the bit sequence antenna 22 supplies to the remainder of the receiver. Thus, no circuitry is required to align matching operations with the boundaries of the sequential bits passing through the optical lines. For example, the outputs of the optical negative exclusive OR and AND gates continuously follow the dynamic inputs thereof. The continuous processing by all of the negative exclusive OR and AND gates tracking the dynamic inputs thereof introduces potential ambiguities in the output signals of the matching circuits.

It is possible for the matching circuits to generate erroneous indications of pattern matches if the splitters are not spaced exactly apart, as described in connection with FIGS. 1 and 3-6. Furthermore, variations in the length of the sequential bits can cause false pattern matching. False pattern matching can also occur if the negative exclusive OR and/or AND gates do not change state immediately in response to the dynamic inputs thereof changing state. In response to an input of one of the gates changing from a presence of optical energy state to a dark state, the output of the optical gate is likely to drop to a dark state more slowly than the change to the dark state at the input port of the gate.

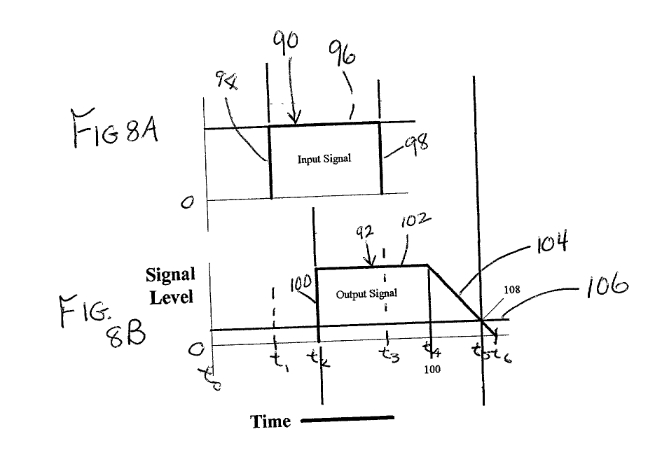

These operations are illustrated in connection with FIGS. 8a and 8b, which respectively plot intensity of optical energy versus time of a dynamic signal at an input port of an optical negative exclusive OR or AND gate, of the type illustrated in any one of FIGS. 1 or 3-6. At the initial time, to, the optical intensity in each of FIGS. 8a and 8b is zero. At some subsequent time, t₁, an optical pulse, represented by waveform 90, is applied to the gate input port; the gate responds to waveform 90 to produce, at its output port, an optical pulse represented by waveform 92.

Waveform 90 has a positive going, very steep leading edge 94 which occurs at time t₁. Upon the completion of leading edge 94, the intensity of optical waveform 90 remains constant at a relatively high value indicated by waveform portion 96. Waveform 90 is completed at time t₃ as indicated by negative going steep trailing edge 98. The output of the gate quickly responds to edge 94 to change from a zero level to produce optical energy at time t₂, as indicated by leading edge 100 of waveform 92. As indicated by waveform portion 102, the intensity at the output port of the gate remains constant after leading edge 100 has been completed for a time equal to the duration of waveform portion 96. Thus edge 100 and waveform portion 102 are respectively slightly delayed replicas of edge 94 and waveform portion 96.

In response to the transition of waveform 90 from constant portion 96 to trailing edge 98, the intensity of the optical energy at the gate output port decreases gradually, as indicated by waveform portion 104. Waveform portion 104 crosses threshold 106 at time t₅ and reaches a zero intensity value at time t₆. Threshold 106 is the threshold between dark and light at the gate output. All values of waveform 92 above threshold 106 are assigned a binary 1 value while intensities equal to or less than threshold 106 are assigned a binary 0, i.e., dark, value. Thus, the intensity at the output port of the gate is associated with a binary 1 value for a longer period than the binary 1 of waveform 90 applied to the input of the gate.

The increase in the duration of the output pulses of each gate relative to the durations of the gate input pulses has an additive effect in the various processing layers of the matching circuits of FIGS. 1 and 3-6. Each layer of the matching circuits causes the pulse to be stretched slightly farther than the previous layer caused the pulse to be stretched. The duration of the stretches is not sufficient, however, to cause adverse affects on the operation of the device, as long as the number of layers is not excessive, that is, does not exceed one half of the duration of a bit in the bit sequence antenna 20 applies to the remainder of the receiver.

The slight delay between the leading edges 94 and 100 of pulses 90 and 92 does not adversely affect the quality of operation, as long as all of the optical negative exclusive OR gates have the same amount of delay and all of the optical AND gates have the same amount of delay. If, however, the negative exclusive OR gates have different delays and/or the AND gates at the same processing level have differing delays between the leading edges of the pulses at the inputs and outputs thereof, adverse operation of the matching circuitry occurs.

Ambiguities, that is, errors, in the ability of the optical circuitry of FIGS. 1 and 3-6, to produce accurate pattern matching results are determined by a number of factors, such as the mechanical tolerances of elements within the circuitry, quality of response (discussed supra), variations in the lengths of the sequential pulses and the relative positions thereof with respect to each other, and variations of these parameters due to temperature and time (aging). Even if the matching circuitry operates flawlessly, errors may occur, in the form of small spikes, that is, narrow pulses, at the output of the matching network. Such errors are likely due to imperfections in the data stream, i.e., different pulses have different durations. Although transmitter 10 may produce perfectly formed data streams, the transmission medium between transmitter 10 and receiver 12, over which the sequential optical data pulses are transmitted, always introduces some level of distortion which affects the shape of the sequential bits. Such narrow pulses typically have a duration substantially less than one half of the duration of a sequential bit in the data stream.

In such instances, it is necessary to remove, i.e., filter out, the narrow, noise like optical pulses, i.e., optical pulses having a duration of no more than one half of a bit duration. Such filtering can be performed at the output of the optical negative exclusive OR and/or optical AND gates of the optical circuits of FIGS. 1 and 3-7.

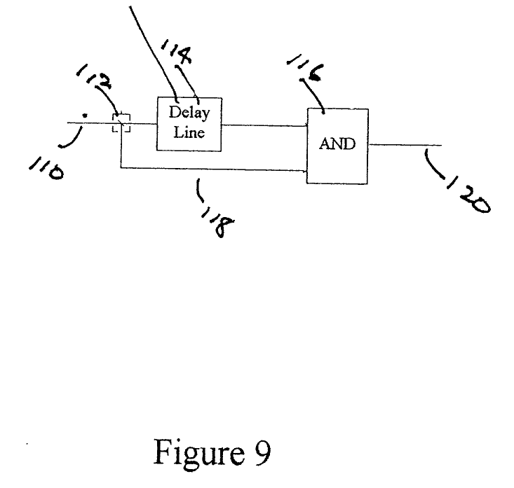

FIG. 9 is a block diagram of optical circuitry for performing such filtering. The output port of such an optical gate is connected to optical line 110 which includes optical splitter 112. One output port of optical splitter 112 drives an input port of optical delay line 114, having an output port which drives an input port of optical AND gate 116. A second input port of AND gate 116 is connected by optical line 118 to the second output port of splitter 112. The delay time of delay line 114 equals the duration of the longest pulse to be filtered out by the circuitry of FIG. 9. AND gate 116 includes an output port which drives optical line 120.

In response to a pulse applied to optical line 110 having a duration equal to or less than the delay time of delay line 114, the output port of AND gate 116 remains dark and no optical signal is supplied to optical line 120. If, however, an optical pulse on line 110 has a duration in excess of the delay time of delay line 114, AND gate 116 supplies optical line 120 with a finite length optical pulse. It may be necessary and/or desirable in certain instances, to connect an optical one shot to line 120. In such an instance, the one shot derives an optical pulse having a length, i.e., duration, equal to the duration of one bit.

While there have been described and illustrated specific embodiments of the invention, it will be clear that variations in the details of the embodiments specifically illustrated and described may be made without departing from the true spirit and scope of the invention as defined in the appended claims.

I claim:

1. A method of determining if sequential binary bits modulating optical energy have a certain bit pattern comprising applying the modulated optical energy to an optical line having plural points from which optical energy is derived; the propagation speed of the optical energy in the optical line, the duration of the optical bits and the locations of the points being such that each of the binary bits passes by each of the points for approximately the same time and the binary bits at the points are substantial replicas of the sequential binary bits modulating the optical energy, and comparing the values of the bits at the points with the certain bit pattern to provide the determination.

2. The method of claim 1 wherein the comparing step is performed with optical circuitry.

3. The method of claim 1 wherein the comparing step results in a delay being introduced into bits being processed to produce the comparing result, and delaying the optical energy so there is synchronism with the modulated bits at a point which causes the comparison to be derived and the bits being processed to produce the comparing result.

4. The method of claim 1 wherein the method is performed for plural sequential sets of modulating optical energy, a first of the sets having a first predetermined bit pattern, a second of the sets having a second predetermined bit pattern, performing the applying and comparing steps for the first and second sets.

5. The method of claim 4 wherein the first and second comparisons occur at different times such that an output resulting from the first comparison occurs before the second comparison, delaying an output resulting from the first comparison so it is in synchronism with an output of the second comparison.

6. The method of claim 1 wherein the propagation speed of the optical energy in the optical line, the duration of the optical bits and the locations of the points are such that the propagation time of the optical energy in the line between at least some adjacent points is equal to the duration of each bit.

7. An apparatus for determining if sequential binary bits modulating optical energy have a certain bit pattern comprising an optical line having plural points from which optical energy is derived; the optical line being adapted to be responsive to the optical energy; the propagation speed of the optical energy in the optical line, the duration of the optical bits and the locations of the points being such that each of the binary bits passes by each of the points for approximately the same time and the binary bits at the points are substantial replicas of the sequential binary bits modulating the optical energy, and circuitry for comparing the values of the bits at the points with the predetermined bit pattern to provide the determination.

8. The apparatus of claim 7 wherein the circuitry is optical.

9. The apparatus of claim 7 wherein the circuitry causes a delay to be introduced into bits being processed thereby, and a delay element connected to be responsive to optical energy at one of the points for providing synchronism between the bits at one of said points and the bits being processed by the circuitry.

10. The apparatus of claim 9 wherein the delay element is in the optical line between adjacent points of the optical line.

11. The apparatus of claim 10 wherein the circuitry includes plural comparison gates, each including first and second input ports respectively connected to be responsive to optical energy at a different one of said points and an indication of a different bit of the pattern, each of the comparison gates including an output port, a further gate arrangement having input ports connected to be responsive to signals at the output ports of a plurality of the comparison gates, the further gate arrangement including cascaded gates for introducing a predetermined delay, the delay element in the line being substantially the same as the introduced delay.

12. The apparatus of claim 9 wherein the delay is in the circuitry.

13. The apparatus of claim 10 wherein line includes an odd number of said points, the circuitry including plural comparison gates, each including first and second input ports respectively connected to be responsive to optical energy at a different one of said points and an indication of a different bit of the pattern, each of the comparison gates including an output port, a further gate arrangement having input ports connected to be responsive to signals at the output ports of a plurality of the comparison gates, the further gate arrangement including a logic tree of plural gates, at least one of the gates having two inputs connected to be responsive to outputs of a pair of the comparison gates, at least one gate causing a predetermined delay to be introduced between the inputs and outputs thereof, an additional gate having a first input connected to be responsive to the signal at the output of the at least one gate and a second input connected to be responsive to an output signal of the delay element, the delay element having a delay equal to the delay of the at least one gate and an input connected to be responsive to a signal at an output of another one of the comparison gates.

14. The apparatus of claim 7 wherein the optical line includes an optical splitter at each of the taps, the optical splitter having an input port connected to be responsive to optical energy propagating in the optical line and first and second output ports respectively connected to drive the optical line and the circuitry.

15. The apparatus of claim 14 further including an optical amplifier connected to be responsive to the optical energy in the line and for supplying amplified optical energy to the line, at least one of the splitters being connected to be responsive to the optical energy derived by the optical amplifier.

16. The apparatus of claim 15 wherein the number of amplifiers equals the number of splitters, the amplifiers and splitters being connected to the line so each of the splitters is connected to be responsive to the amplified optical energy of a different optical amplifier.
